(19) United States
(12) Patent Application Publication
(10) Pub. No.: US 2026/0282151 A1
(43) Pub. Date: Sep. 17, 2026

(54) MECHANISM FOR SMALL DATA TRANSMISSION

(71) Applicant: Nokia Technologies Oy, Espoo (FI)

(72) Inventors: Samuli Heikki Turtinen, Ii (FI); Jussi-Pekka Koskinen, Oulu (FI); Chunli Wu, Beijing (CN)

(73) Assignee: Nokia Technologies Oy, Espoo (FI)

(21) Appl. No.: 19/470,937

(22) PCT Filed: Mar. 30, 2023
(86) PCT No.: PCT/CN2023/085262

§ 371 Date: Sep. 30, 2025

(51) Int. Cl. H04W 76/20; H04W 72/12; H04W 74/0833; H04W 76/19

(52) U.S. Cl. CPC H04W 76/20; H04W 72/12; H04W 74/0833; H04W 76/19

(57) ABSTRACT

Example embodiments of the present disclosure related to configuration small data transmission (SDT). A terminal device transmits, to a network device, information indicating a set of radio bearers applicable to be configured in at least one small data transmission configuration. In this way, the network device is able to properly configure the radio bear(s) for the SDT.

### FIELD

Various example embodiments of the present disclosure generally relate to the field of telecommunication and in particular, to methods, devices, apparatuses and computer readable storage medium for small data transmission.

### BACKGROUND

With developments of communication systems, new technologies have been proposed. For example, small data transmission (SDT) has been proposed. Specifically, the SDT is a transmission for a short data burst in a connectionless state where a device does not need to establish and teardown connections when small amounts of data need to be sent. Moreover, a Mobile Terminated-Small Data Transmission (MT-SDT) and Mobile Originated SDT (MO-SDT) are also proposed. Therefore, it is worth studying on properly configuring the SDT.

### SUMMARY

In a first aspect of the present disclosure, there is provided an apparatus. The apparatus comprises at least one processor; and at least one memory storing instructions that, when executed by the at least one processor, cause the apparatus to perform: transmitting, to a network device, information indicating a set of radio bearers applicable to be configured in at least one small data transmission configuration.

In a second aspect of the present disclosure, there is provided an apparatus. The apparatus comprises at least one processor; at least one memory storing instructions that, when executed by the at least one processor, cause the apparatus to perform: receiving, from a terminal device, information indicating a set of radio bearers applicable to be configured in at least one small data transmission configuration.

In a third aspect of the present disclosure, there is provided a method. The method comprises: transmitting, by a terminal device and to a network device, information indicating a set of radio bearers applicable to be configured in at least one small data transmission configuration.

In a fourth aspect of the present disclosure, there is provided a method. The method comprises: receiving, by a network device and from a terminal device, information indicating a set of radio bearers applicable to be configured in at least one small data transmission configuration.

In a fifth aspect of the present disclosure, there is provided an apparatus. The apparatus comprises: means for transmitting, to a network device, information indicating a set of radio bearers applicable to be configured in at least one small data transmission configuration.

In a sixth aspect of the present disclosure, there is provided an apparatus. The apparatus comprises: means for receiving, from a terminal device, information indicating a set of radio bearers applicable to be configured in at least one small data transmission configuration.

In a seventh aspect of the present disclosure, there is provided a non-transitory computer readable medium. The non-transitory computer readable medium comprising program instructions that, when executed by an apparatus, cause the apparatus to perform at least the following transmitting, to a network device, information indicating a set of radio bearers applicable to be configured in at least one small data transmission configuration.

In an eighth aspect of the present disclosure, there is provided a non-transitory computer readable medium. The non-transitory computer readable medium comprising program instructions that, when executed by an apparatus, cause the apparatus to perform at least the following receiving, from a terminal device, information indicating a set of radio bearers applicable to be configured in at least one small data transmission configuration.

In a ninth aspect of the present disclosure, there is provided a computer program. The computer program comprising instructions which, when executed by an apparatus, cause the apparatus to perform transmitting, to a network device, information indicating a set of radio bearers applicable to be configured in at least one small data transmission configuration.

In a tenth aspect of the present disclosure, there is provided a computer program. The computer program comprising instructions which, when executed by an apparatus, cause the apparatus to perform receiving, from a terminal device, information indicating a set of radio bearers applicable to be configured in at least one small data transmission configuration.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2A to FIG. 2C illustrate examples of signaling charts for SDT;

FIG. 3 illustrates a signaling chart for communication according to some example embodiments of the present disclosure;

FIG. 4 illustrates a schematic diagram of configured grant (CG) resources;

FIG. 5 illustrates a flowchart of a method according to some example embodiments of the present disclosure;

FIG. 6 illustrates a flowchart of a method according to some further example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “small data transmission (SDT)” may refer to a procedure allowing data and/or signalling transmission while remaining in radio resource control (RRC)_INACTIVE state (i.e. without transitioning to RRC_CONNECTED state). Specifically, the SDT is a transmission for a short data burst in a connectionless state where a device does not need to establish and teardown connections when small amounts of data need to be sent. The term “radio bearer (RB)” used herein may refer to a tunnel that can take and carry information from one end to another end. The term “data radio bearer (DRB)” used herein may refer to a radio bearer that is established for transmissions of data plane packets. The term “signaling radio bearer (SRB)” used herein may refer to a radio bearer that is used for transmissions of signaling message, for example, radio resource control (RRC) message, non-access stratum (NAS) message.

Service Data Adaptation Protocol (SDAP) sublayer exists only in the user plane in both gNB and UE. It interfaces to upper layers via QoS flows and to the PDCP lower layer via Data Radio Bearers (DRBs). Traffic from QoS flows are mapped to suitable DRBs. This is an essential role of SDAP. SDAP layer doesn't exist in 4G/LTE since QoS flows were introduced only in 5G. Quality-of-Service (QoS) is implemented in 5G using QoS Flows. On the Uu air interface between gNB and UE, data packets are carried in DRBs. Rules are either configured or derived to map QoS flows to DRBs. This mapping is executed at SDAP.

As mentioned above, it is worth studying on properly configuring the SDT. For example, it is up to gNB implementation to configure number of DRBs or SRB2 that is bearer is dedicated to a single UE and it carries dedicated RRC signalling messages to be used for SDT by UE upon MO-SDT procedure initiation or upon MT-SDT procedure indication by NW. However, the services used by the UE over a certain DRB are not quite visible to gNB and deciding on DRBs suitable for SDT may be difficult. SRB2 is for NAS messages, all using dedicated control channel (DCCH) logical channel. SRB2 has a lower-priority than SRB1 and is always configured by the network after security activation.

In some solutions, UE assistance information may be used for preconfigured uplink resource (PUR) configurations and CG-SDT configurations. However, both cases mainly focus on assistance information for CG configuration, other than whether a RB is suitable for SDT at all. Neither also helps NW in configuring the RBs for SDT. Therefore, solutions on configuration SDT are needed.

According to embodiments of the present disclosure, a terminal device transmits, to a network device, information indicating a set of radio bearers applicable to be configured in at least one small data transmission configuration. In this way, the network device is able to properly configure the radio bear(s) for the SDT.

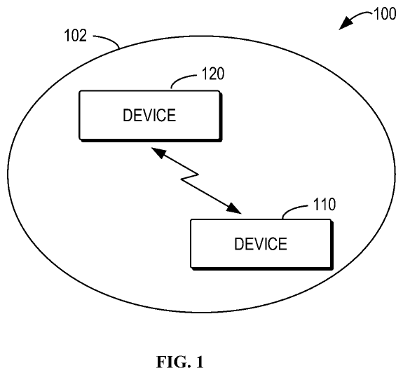

FIG. 1 illustrates an example communication environment 100 in which example embodiments of the present disclosure can be implemented. In the communication environment 100, a plurality of communication devices, including a device 110 and a device 120, can communicate with each other.

In the example of FIG. 1, the device 110 may include a terminal device and the device 120 may include a network device serving the terminal device. The serving area of the device 120 may be called a cell 102.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the device 120 may be other device than a network device. Although illustrated as a terminal device, the device 110 may be other device than a terminal device.

In the following, for the purpose of illustration, some example embodiments are described with the device 110 operating as a terminal device and the device 120 operating as a network device. However, in some example embodiments, operations described in connection with a terminal device may be implemented at a network device or other device, and operations described in connection with a network device may be implemented at a terminal device or other device.

In some example embodiments, if the device 110 is a terminal device and the device 120 is a network device, a link from the device 120 to the device 110 is referred to as a downlink (DL), while a link from the device 110 to the device 120 is referred to as an uplink (UL). In DL, the device 120 is a transmitting (TX) device (or a transmitter) and the device 110 is a receiving (RX) device (or a receiver). In UL, the device 110 is a TX device (or a transmitter) and the device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

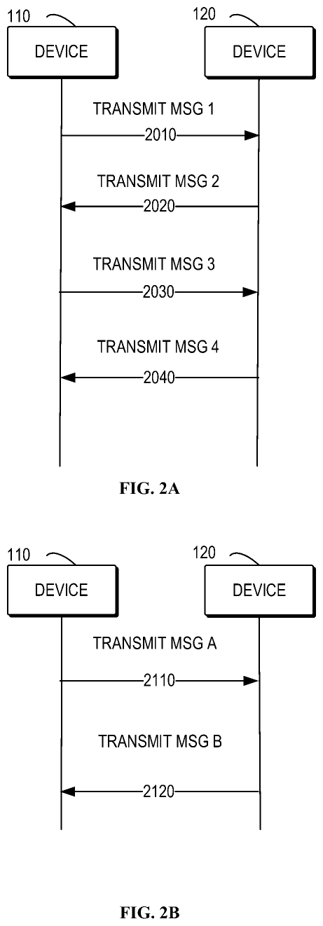

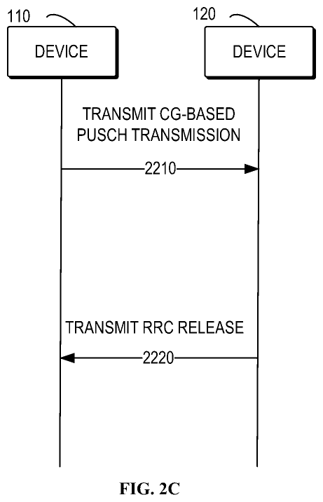

SDT can be applied to the communication environment 100. For example, the MT-SDT and the MO-SDT may be applied to the communication environment 100. SDT is enabled on a radio bearer basis and is initiated by the terminal device only if less than a configured amount of UL data awaits transmission across all radio bearers for which SDT is enabled, the DL reference signal received power (RSRP) is above a configured threshold, and a valid SDT resource is available. FIG. 2A to FIG. 2C illustrate examples of signaling charts for SDT that can be applied in the communication environment 100.

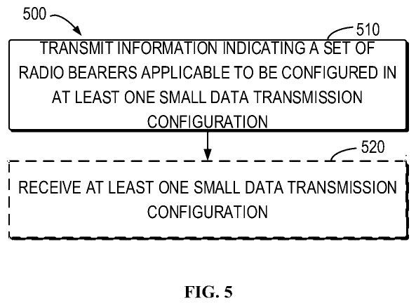

FIG. 2A shows a schematic diagram of interactions for 4-step random access channel (RACH) based SDT (i.e. 4-step RA-SDT). As shown in FIG. 2A, the device 110 can transmit (2010) a message 1 (MSG 1) to the device 120 when the device 110 is in a radio resource control (RRC) inactive state. The MSG 1 comprises a preamble for the RACH. The device 120 can transmit (2020) a message 2 (MSG 2) to the device 110. The MSG 2 comprises a random access response. The device 110 can transmit (2030) a message 3 (MSG 3) to the device 120. The MSG 3 comprises a RRC connection resume request. A small payload (i.e., the small data) can be transmitted in the MSG 3. For example, the small payload can be multiplexed with the RRC connection resume request. The device 120 can transmit (2040) a RRC release message. FIG. 2B shows a schematic diagram of interactions for 2-step RACH based SDT (i.e. 2-step RA-SDT). As shown in FIG. 2B, when the device 110 is in the RRC inactive state, the device 110 may transmit (2110) a message A (MSG A) to the device 120. The MSG A can comprise a preamble for the RACH. The small data can be transmitted with the MSG A. In particular, the small data can be transmitted on physical uplink shared channel (PUSCH) resources that are pre-configured by the device 120 and are broadcasted in system information with associated physical transmission parameters. The device 120 may transmit (2120) a message B (MSG B) to the terminal device 110. The MSG B comprises a random access response. FIG. 2C shows a schematic diagram of interactions for Configured Grant based SDT (i.e. CG-SDT). When the device 110 is in a RRC Connected state, the device 110 can receive (2210) a CG type1 configuration that indicates specific pre-configured PUSCH resources to be used for UL data transmission in RRC inactive as long as the timing alignment is valid. For example, as shown in FIG. 4, the CG resources 410-1, 410-2, 410-3, 410-4 and 410-5 may be configured for SDT. It is noted that the number The device 120 can transmit (2220) a RRC release message.

Example embodiments of the present disclosure will be described in detail below with reference to the accompanying drawings.

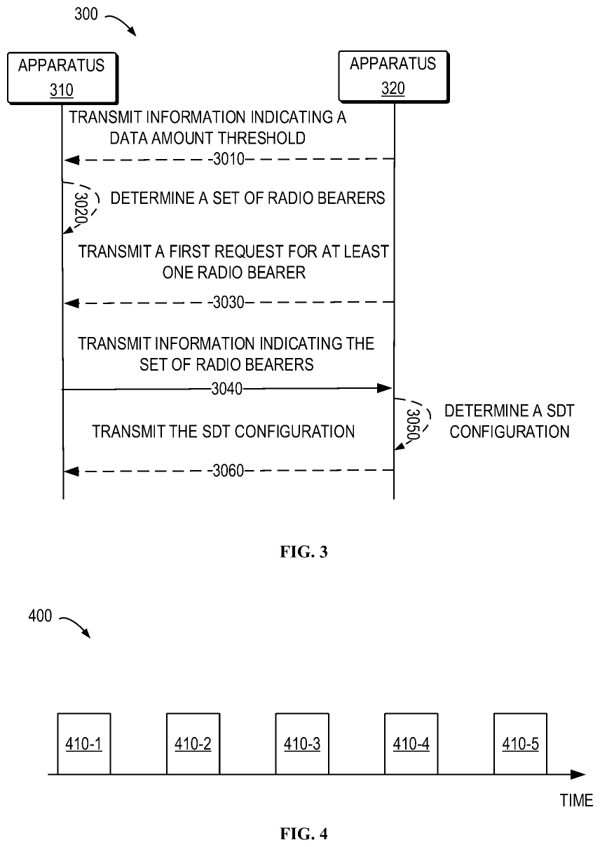

Reference is now made to FIG. 3, which shows a signaling chart 300 for communication according to some example embodiments of the present disclosure. As shown in FIG. 3, the signaling chart 300 involves an apparatus 310 and an apparatus 320. For example, the apparatus 310 may be implemented at the device 110 and the apparatus 320 may be implemented at the device 120.

In some example embodiments, the apparatus 310 may determine (3020) a set of radio bearers applicable to be configured in at least one small data transmission configuration. By way of example, the set of radio bearers may only include one radio bearer. Alternatively, the set of radio bearers may include more than one radio bearer. In some example embodiments, the set of radio bearers may include one or more SRBs. Alternatively, or in addition, the set of radio bearers may include one or more DRBs.

In an example embodiment, the apparatus 310 may determine an application for a radio bearer. In other words, the application can be mapped to the radio bearer. In this case, the apparatus 310 may determine whether the radio bearer is for the small data transmission based on application level information of the application. The application level information may include any proper information associated with the application. For example, if the application level information indicates that the application needs a large amount of data, the apparatus 310 may determine that the radio bearer is not suitable for the small data transmission. Alternatively, if the application level information indicates that the amount of data required by the application is not above a data amount threshold, the apparatus 310 may determine that the radio bearer can be used for the small data transmission. As another example, if the application level information that the application is an online game application, the apparatus 310 may determine that the radio bearer is not suitable for the small data transmission. Difference radio bearers may be used for different types of services and/or support different quality of service requirements. For example, if the application level information that the application is associated with a service that needs a small amount of data, the apparatus 310 may determine that the radio bearer can be used for the small data transmission. It is noted that the data amount threshold may be any suitable amount and may be configured by the network or preconfigured.

Alternatively, or in addition, the apparatus 310 may determine amount of data associated with the application. In this case, the apparatus 310 may determine whether the radio bearer is suitable for the small data transmission based on the amount of data associated with the application. The amount of data may include data transmitted by the application and/or data received by the application. For example, if the amount of data is above a data amount threshold, the apparatus 310 may determine that the radio bearer is not suitable for the small data transmission. If the amount of data is not above the data amount threshold, the apparatus 310 may determine that the radio bearer is suitable for the small data transmission. It is noted that the data amount threshold may be any suitable amount and may be configured by the network or preconfigured.

In some other example embodiments, if the apparatus 310 determines that a large amount of data is expected on the radio bearer, the apparatus 310 may determine that the radio bearer is not suitable for the small data transmission. For example, if the radio bearer is for a service that requires a large amount of data, the apparatus 310 may determine that the radio bearer is not suitable for the small data transmission. The large amount of data may exceed a predetermined data amount threshold.

In an example embodiment, the apparatus 310 may determine data amount history information of a radio bearer. In this case, the apparatus 310 may determine whether the radio bearer is suitable for the small data transmission based on the data amount history information. By way of example, the apparatus may store history information on transmitted and/or received data on the radio bearer. Whether the radio bearer is suitable for the small data transmission may be determined based on the stored history information. For example, if the data amount history information indicates that the largest amount of data of the radio bearer is not above a data amount threshold, the apparatus 310 may determine that the radio bearer is suitable for the small data transmission. As another example, if the data amount history information indicates that the smallest amount of data of the radio bearer is above the data amount threshold, the apparatus 310 may determine that the radio bearer is not suitable for the small data transmission. It is noted that the data amount threshold may be any suitable amount and may be configured by the network or preconfigured.

The apparatus 320 may transmit (3010) information indicating a data amount threshold for initiating a small data transmission procedure to the apparatus 310. In other words, the apparatus 310 may receive the information indicating the data amount threshold. For example, the small data transmission procedure can be indicated if an amount of data is not above the data amount threshold. In this case, the set of radio bearers applicable to be configured in the at least one small data transmission configuration may be determined (3020) based on the received data amount threshold. For example, if the amount of data on the radio bearer is not above the data amount threshold, the apparatus 310 may determine that the radio bearer is suitable for the one or more small data transmissions. Alternatively, if the amount of data on the radio bearer is above the data amount threshold, the apparatus 310 may determine that the radio bearer is not suitable for the one or more small data transmissions. The amount of data on the radio bearer may be determined in a similar way as above embodiments. For example, the amount of data on the radio bearer may be determined based on the application level information or the data amount history information of the radio bearer.

The apparatus 310 transmits (3040) information indicating the set of radio bearers applicable to be configured in at least one small data transmission configuration to the apparatus 320. In this way, the radio bear(s) for the SDT can be configured properly.

In some example embodiments, the apparatus 310 may indicate the set of radio bearers to the apparatus 320 when the apparatus 310 is in a RRC_CONNECTED mode. Alternatively, the apparatus 310 may indicate the set of radio bearers to the apparatus 320 during the SDT procedure in a RRC_ INACTIVE mode.

In some example embodiments, the apparatus 320 may transmit (3030) a first request for indicating at least one radio bearer applicable to be configured in the at least one small data transmission configuration. In this case, after receiving the first request, the apparatus 310 may transmit (3040) the information indicating the set of radio bearers to the apparatus 320. In some other example embodiments, the first request may be received/transmitted before the information indicating the data amount threshold. Alternatively, the first request and the information indicating the data amount threshold may be received/transmitted at the same time. It is noted that the order of transmitting the information indicating the data amount threshold and transmitting the first request is not limited to the example shown in FIG. 3.

The information indicating the set of radio bearers may be transmitted via any proper signalling. For example, in some example embodiments, the information may be transmitted in UE assistance information. For example, one or more information elements (IEs) may be introduced in the UE assistance information to indicate the set of radio bearers. Alternatively, the information may be transmitted in a RRC message. By way of example, the information may be transmitted in a RRC resume complete message. As another example, the information may be transmitted in a RRC reconfiguration complete message. In some other examples, a RRC setup complete message may include the information.

In some example embodiments, the set of radio bearers may be preferred by the apparatus 310. For example, the apparatus 310 may indicate the preferred radio bearers for SDT upon the apparats 320 configures the apparatus 310 to report preferred radio bearers.

Alternatively, the apparatus 310 may determine whether there is a change on the set of radio bearers. In this case, if there is a change on the set of radio bearers, the apparatus 310 may transmit further indication indicating the set of radio bearers to the apparatus 320. By way of example, if the application for the radio bearer is changed and the changed application needs more amount of data than the previous application, the apparatus 310 may determine that such radio bearer is no longer suitable for the small data transmission. In this case, the set of radio bearers indicated in the further information may not include said radio bearer. As another example, if the amount of data transmitted/received on a radio bearer is decreased and is below a data amount threshold, the apparatus 310 may determine that that radio bearer is no longer suitable for the small data transmission. In this case, said radio bearer can be added into the set of radio bearers indicated in the further information.

The information transmitted (3040) by the apparatus 310 may also indicate whether the apparatus 310 prefers or not to configure a default data radio bearer in the at least one small data transmission configuration. By way of example, if the QoS of the default data radio bearer does not meet a requirement of the small data transmission, the information may indicate that the apparatus 310 does not prefer to configure the default data radio bearer for the small data transmission. As another example, if the data amount history information of the default data radio bearer indicates that the largest amount of data of the radio bearer is not above a data amount threshold, the apparatus 310 may determine that the default radio bearer is suitable for the small data transmission.

In an example embodiment, the apparatus 310 may not indicate a radio bearer for voice or a guaranteed bit rate (GBR) radio bearer is suitable for the small data transmissions. For example, in some example embodiments, the first information may explicitly indicate that the radio bearer for voice or the GBR radio bearer is not suitable for the one or more small data transmissions. Alternatively, or in addition, the set of radio bearers excludes (or does not include) the radio bearer for voice or the GBR radio bearer.

Alternatively, or in addition, the information transmitted (3040) by the apparatus 310 may further indicate one or more: identity information or expected amount of data for a radio bearer in the set of radio bearers. For example, the information may include a radio bearer identity of the radio bearer. The expected amount of data for the radio bearer may be determined based on a service request for the radio bearer.

In some other example embodiments, the information transmitted (3040) by the apparatus 310 further indicates whether a radio bearer in the set of radio bearers is suitable for at least one of: a configured grant small data transmission or a random access small data transmission. By way of example, if a traffic pattern of the radio bearer is not deterministic, the apparatus 310 may determine that this radio bearers is suitable for the random access small data transmission and not suitable for the configured grant small data transmission. In this case, in some example embodiments, the information may indicate that the radio bearer in the set of radio bearers is suitable for the random access small data transmission. Alternatively, the information transmitted (3040) by the apparatus 310 may indicate that the radio bearer in the set of radio bearers is unsuitable for the configured grant small data transmission. It is noted the whether the radio bearer is suitable for the configured grant small data transmission or the random access small data transmission may be determined based on any proper information.

In an example embodiment, the information transmitted (3040) by the apparatus 310 may indicate that a radio bearer in the set of radio bearers is for uplink. In another example embodiment, the information may indicate that a radio bearer in the set of radio bearers is for downlink. Alternatively, the information may indicate that a radio bearer in the set of radio bearers is for both uplink and downlink. For example, the apparatus 310 can indicate that the radio bearer is suitable for the small data transmission separately for UL and DL and/or jointly for UL and DL.

Alternatively, or in addition, the information transmitted (3040) by the apparatus 310 may indicate expected amount of data for uplink transmission and expected amount of data for downlink transmission. In some example embodiments, the information transmitted (3040) by the apparatus 310 may indicate time after which data activity is expected on a radio bearer in the set of radio bearers.

In some example embodiments, the apparatus 320 may determine (3050) the at least one small data transmission configuration based on the information. For example, the at least one small data transmission configuration may indicate one or more radio bearers that are used for the small data transmission. By way of example, the at least one small data transmission configuration may indicate the set of radio bearers transmitted (3040) in the information. As an example, the at least one small data transmission configuration may include radio bearer IDs indicated in the information. That is to say, the apparatus 320 may configure the set of radio bearers to the apparatus 310.

In an example embodiment, the at least one small data transmission configuration may indicate a SDT DRB list. For example, the at least one small data transmission configuration may include the ID(s) of data radio bearer(s) configured for the small data transmission. In this case, if a size of the SDT DRB list is zero, then the apparatus 310 may assume that none of the data radio bearers are configured for small data transmission. The apparatus 320 may only configure master node (MN) terminated master cell group (MCG) bearers for small data transmission.

In another example embodiment, the least one small data transmission configuration may include a SDT SRB2 indication. For example, the at least one small data transmission configuration may indicate whether the SRB2 is configured for the small data transmission or not.

In some example embodiments, as mentioned above, the information transmitted (3040) by the apparatus 310 may indicate expected amount of data for uplink transmission and expected amount of data for downlink transmission. In this case, the apparatus 320 may determine a first set of radio bearers for a mobile originated small data transmission and a second set of radio bearers for a mobile terminated small data transmission based on the information. The at least one small data transmission configuration may indicate the first set of radio bearers for a mobile originated small data transmission and the second set of radio bearers for a mobile terminated small data transmission based on the information. Alternatively, if the information transmitted (3040) by the apparatus 310 may indicate time after which data activity is expected on a radio bearer in the set of radio bearers, the apparatus 320 may determine whether CG-SDT is suitable for the radio bearer or UE to be configured based on the information. In this case, the at least one small data transmission configuration may indicate determine whether CG-SDT is suitable for the radio bearer or UE to be configured.

The apparatus 320 may transmit (3060) the at least one small data transmission configuration to the apparatus 310. The at least one small data transmission configuration may be transmitted via any proper signalling. For example, in some example embodiments, the at least one small data transmission configuration may be transmitted via a broadcast signalling. Alternatively, the radio bearer configuration may be transmitted via a RRC signalling.

According to embodiments described with reference to FIG. 3, the terminal device indicates one or more radio bearers suitable for at least one small data transmission to the network device. In this case, the network is able to configure the SDT bearers properly in which case the probability to take advantage of SDT increases.

FIG. 5 shows a flowchart of an example method 500 implemented at an apparatus in accordance with some example embodiments of the present disclosure. For the purpose of discussion, the method 500 will be described from the perspective of the device 110 in FIG. 1.

At block 510, the device 110 transmits, to the device 120, information indicating a set of radio bearers applicable to be configured in at least one small data transmission configuration. In some example embodiments, the set of radio bearers comprises one or more radio bearers. In some example embodiments, the information is comprised in at least one of: user equipment assistance information, a radio resource control resume complete message, a radio resource control setup complete message, or a radio resource control reconfiguration complete message.

In some example embodiments, the device 110 may receive, from the device 120, a first request for indicating at least one radio bearer applicable to be configured in the at least one small data transmission configuration. In this case, the device 110 may transmit, to the device 120, the information indicating the set of radio bearers.

In some example embodiments, the device 110 may receive, from the device 120, other information indicating a data amount threshold for initiating a small data transmission procedure. In some example embodiments, the device 110 may determine the set of radio bearers based on the data amount threshold.

In some example embodiments, the device 110 may determine that there is a change on the set of radio bearers. In this case, based on the determining that there is the change on the set of radio bearers, the device 110 may determine transmit, to the device 120, further information indicating the set of radio bearers.

In some example embodiments, the information further indicates whether the apparatus prefers or not to configure a default data radio bearer in the at least one small data transmission configuration. In some example embodiments, the information further indicates a radio bearer for voice or a guaranteed bit rate (GBR) radio bearer is not applicable to be configured in the at least one small data transmission configuration. In some example embodiments, the set of radio bearers excludes the radio bearer for voice or the GBR radio bearer.

In some example embodiments, the information further indicates at least one of: identity information or expected amount of data for a radio bearer in the set of radio bearers. In some example embodiments, the information further indicates whether a radio bearer in the set of radio bearers is suitable for at least one of: a configured grant small data transmission or a random access small data transmission.

In some example embodiments, the information further indicates that a radio bearer in the set of radio bearers is for uplink, or downlink, or both uplink and downlink. In some example embodiments, the information further indicates expected amount of data for uplink transmission and expected amount of data for downlink transmission. In some example embodiments, the information further indicates time after which data activity is expected on a radio bearer in the set of radio bearers.

In some example embodiments, at block 520, the device 110 may receive, from the device 120, the at least one small data transmission configuration is determined based on the information by the device 120. In this case, the at least one small data transmission configuration may indicate a first set of radio bearers suitable for at least one mobile originated small data transmission and a second set of radio bearers suitable for at least one mobile terminated small data transmission.

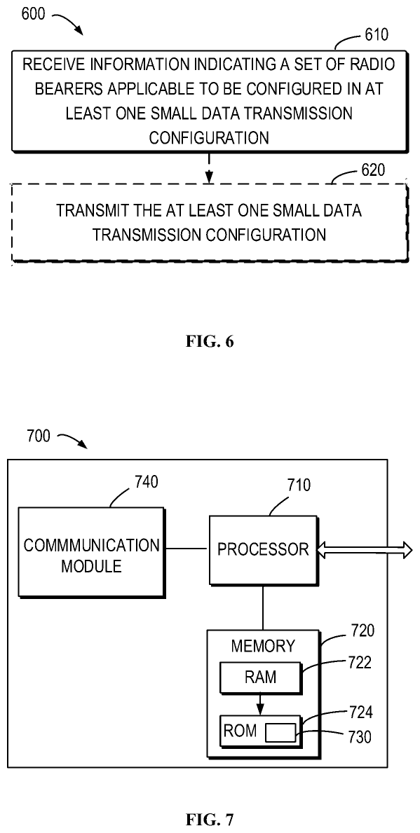

FIG. 6 shows a flowchart of an example method 600 implemented at an apparatus in accordance with some example embodiments of the present disclosure. For the purpose of discussion, the method 600 will be described from the perspective of the device 120 in FIG. 1.

At block 610, the device 120 receives, from the device 110, information indicating a set of radio bearers applicable to be configured in at least one small data transmission configuration. In some example embodiments, the set of radio bearers comprises one or more radio bearers. In some example embodiments, the information is comprised in at least one of: user equipment assistance information, a radio resource control resume complete message, a radio resource control setup complete message, or a radio resource control reconfiguration complete message.

In some example embodiments, the device 120 may determine the at least one small data transmission configuration based on the information. In this case, in some example embodiments, at block 620, the device 120 may transmit the at least one small data transmission configuration to the device 110.

In some example embodiments, the device 120 may transmit to the device 110, a first request for at least one radio bearer applicable to be configured in the at least one small data transmission configuration. In some example embodiments, the device 120 may receive, from the device 110, the information indicating the set of radio bearers. In some example embodiments, the device 120 may transmit to the device 110 other information indicating a data amount threshold for at least one small data transmission. In some example embodiments, if there is a change on the set of radio bearers, the device 120 may receive from the device 110 further information indicating the set of radio bearers.

In some example embodiments, the information further indicates whether the terminal device prefers or not to configure a default data radio bearer in the at least one small data transmission configuration. In some example embodiments, the information further indicates a radio bearer for voice or a guaranteed bit rate (GBR) radio bearer is not applicable to be configured in the at least one small data transmission configuration. In some example embodiments, the set of radio bearers excludes the radio bearer for voice or the GBR radio bearer.

In some example embodiments, the information further indicates at least one of: identity information of the set of radio bearers or expected amount of data for a radio bearer in the set of radio bearers. In some example embodiments, the information further indicates whether a target radio bearer in the set of radio bearers is suitable for at least one of: a configured grant small data transmission or a random access small data transmission.

In some example embodiments, the information further indicates that a radio bearer in the set of radio bearers is for uplink, or downlink, or both uplink and downlink. In some example embodiments, the at least one small data transmission configuration may indicate indicates a first set of radio bearers for a mobile originated small data transmission and a second set of radio bearers for a mobile terminated small data transmission.

In some example embodiments, the information further indicates expected amount of data for uplink transmission and expected amount of data for downlink transmission. In some example embodiments, the information further indicates time after which data activity is expected on the set of radio bearers. In this case, the device 120 may determine whether a configured grant small data transmission is suitable for the set of radio bearers based on the time.

In some example embodiments, an apparatus capable of performing any of the method 500 (for example, the device 110 in FIG. 1) may comprise means for performing the respective operations of the method 500. The means may be implemented in any suitable form. For example, the means may be implemented in a circuitry or software module. The apparatus may be implemented as or included in the device 110 in FIG. 1.

In some example embodiments, the apparatus comprises means for transmitting, to a network device, information indicating a set of radio bearers applicable to be configured in at least one small data transmission configuration.

In some example embodiments, the apparatus comprises means for receiving, from the network device, a first request for indicating at least one radio bearer applicable to be configured in the at least one small data transmission configuration; and means for transmitting, to the network device, the information indicating the set of radio bearers.

In some example embodiments, the apparatus comprises means for receiving, from the network device, other information indicating a data amount threshold for initiating a small data transmission procedure; and means for determining the set of radio bearers based on the data amount threshold.

In some example embodiments, the apparatus comprises means for determining that there is a change on the set of radio bearers; and means for based on the determining that there is the change on the set of radio bearers, transmitting, to the network device, further information indicating the set of radio bearers.

In some example embodiments, the information further indicates whether the apparatus prefers or not to configure a default data radio bearer in the at least one small data transmission configuration.

In some example embodiments, the information further indicates a radio bearer for voice or a guaranteed bit rate (GBR) radio bearer is not applicable to be configured in the at least one small data transmission configuration, or wherein the set of radio bearers excludes the radio bearer for voice or the GBR radio bearer.

In some example embodiments, the information further indicates at least one of: identity information or expected amount of data for a radio bearer in the set of radio bearers.

In some example embodiments, the information further indicates whether a radio bearer in the set of radio bearers is suitable for at least one of: a configured grant small data transmission or a random access small data transmission.

In some example embodiments, the information further indicates that a radio bearer in the set of radio bearers is for uplink, or downlink, or both uplink and downlink.

In some example embodiments, the information further indicates expected amount of data for uplink transmission and expected amount of data for downlink transmission.

In some example embodiments, the information further indicates time after which data activity is expected on a radio bearer in the set of radio bearers.

In some example embodiments, the apparatus comprises means for receiving, from the network device, the at least one small data transmission configuration that is determined based on the information by the network device, wherein the radio bearer configuration indicates a first set of radio bearers configured for at least one mobile originated small data transmission and a second set of radio bearers configured for at least one mobile terminated small data transmission.

In some example embodiments, the information is comprised in at least one of: user equipment assistance information, a radio resource control resume complete message, a radio resource control setup complete message, or a radio resource control reconfiguration complete message.

In some example embodiments the apparatus comprises a terminal device.

In some example embodiments the set of radio bearers comprises one or more radio bearers.

In some example embodiments, an apparatus capable of performing any of the method 600 (for example, the device 120 in FIG. 1) may comprise means for performing the respective operations of the method 900. The means may be implemented in any suitable form. For example, the means may be implemented in a circuitry or software module. The apparatus may be implemented as or included in the device 120 in FIG. 1.

In some example embodiments, the apparatus comprises means for receiving, from a terminal device, information indicating a set of radio bearers applicable to be configured in at least one small data transmission configuration.

In some example embodiments, the apparatus comprises means for determining the at least one small data transmission configuration based on the information; and means for transmitting, to the terminal device, the at least one small data transmission configuration.

In some example embodiments, the apparatus comprises means for transmitting, to the terminal device, a first request for indicating at least one radio bearer applicable to be configured in the at least one small data transmission configuration; and means for receiving, from the terminal device, the information indicating the set of radio bearers.

In some example embodiments, the apparatus comprises means for transmitting, to the terminal device, other information indicating a data amount threshold for initiating a small data transmission procedure.

In some example embodiments, the apparatus comprises means for based on determining that there is a change on the set of radio bearers, receiving, from the terminal device, further information indicating the set of radio bearers.

In some example embodiments, the information further indicates whether the terminal device prefers or not to configure a default data radio bearer in the at least one small data transmission configuration.

In some example embodiments, the information further indicates a radio bearer for voice or a guaranteed bit rate (GBR) radio bearer is not applicable to be configured in the at least one small data transmission configuration, or wherein the set of radio bearers excludes the radio bearer for voice or the GBR radio bearer.

In some example embodiments, the information further indicates at least one of: identity information of the set of radio bearers or expected amount of data for a radio bearer in the set of radio bearers.

In some example embodiments, the information further indicates whether a target radio bearer in the set of radio bearers is suitable for at least one of: a configured grant small data transmission or a random access small data transmission.

In some example embodiments, the information further indicates that a radio bearer in the set of radio bearers is for uplink, or downlink, or both uplink and downlink.

In some example embodiments, the apparatus comprises means for transmitting the at least one small data transmission configuration to the terminal device, wherein the at least one small data transmission configuration indicates a first set of radio bearers for a mobile originated small data transmission and a second set of radio bearers for a mobile terminated small data transmission.

In some example embodiments, the information further indicates expected amount of data for uplink transmission and expected amount of data for downlink transmission.

In some example embodiments, the information further indicates time after which data activity is expected on the set of radio bearers. In some example embodiments, the apparatus comprises means for determining whether a configured grant small data transmission is suitable for the set of radio bearers based on the time.

In some example embodiments, the information is transmitted in one of: user equipment assistance information, a radio resource control resume complete message, a radio resource control setup complete message, or a radio resource control reconfiguration complete message.

In some example embodiments, the apparatus comprises a network device.

In some example embodiments, the set of radio bearers comprises one or more radio bearers.

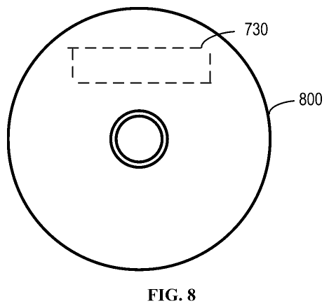

FIG. 7 is a simplified block diagram of a device 700 that is suitable for implementing example embodiments of the present disclosure. The device 700 may be provided to implement a communication device, for example, the device 110 or the device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 1024. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus to perform:
transmitting, to a network device, information indicating a set of radio bearers applicable to be configured in at least one small data transmission configuration.

2. The apparatus of claim 1, wherein the apparatus is caused to perform:
receiving, from a network device, a first request for indicating at least one radio bearer applicable to be configured in the at least one small data transmission configuration; and
transmitting, to the network device, the information indicating the set of radio bearers.

3. The apparatus of claim 1, wherein the apparatus is caused to perform:
receiving, from the network device, other information indicating a data amount threshold for initiating a small data transmission procedure; and
determining the set of radio bearers based on the data amount threshold.

4. The apparatus of claim 1, wherein the apparatus is caused to perform:
determining that there is a change on the set of radio bearers; and
based on the determining that there is the change on the set of radio bearers, transmitting, to the network device, further information indicating the set of radio bearers.

5. The apparatus of claim 1, wherein the information further indicates whether the apparatus prefers or not to configure a default data radio bearer in the at least one small data transmission configuration.

6. The apparatus of claim 1, wherein the information further indicates a radio bearer for voice or a guaranteed bit rate (GBR) radio bearer is not applicable to be configured in the at least one small data transmission configuration, or
wherein the set of radio bearers excludes the radio bearer for voice or the GBR radio bearer.

7. The apparatus of claim 1, wherein the information further indicates at least one of: identity information or expected amount of data for a radio bearer in the set of radio bearers.

8. The apparatus of claim 1, wherein the information further indicates whether a radio bearer in the set of radio bearers is suitable for at least one of: a configured grant small data transmission or a random access small data transmission.

9. The apparatus of claim 1, wherein the information further indicates that a radio bearer in the set of radio bearers is for uplink, or downlink, or both uplink and downlink.

10. The apparatus of claim 1, wherein the information further indicates expected amount of data for uplink transmission and expected amount of data for downlink transmission.

11. The apparatus of claim 1, wherein the information further indicates time after which data activity is expected on a radio bearer in the set of radio bearers.

12. The apparatus of claim 1, wherein the apparatus is caused to perform:
receiving, from the network device, the at least one small data transmission configuration that is determined based on the information by the network device, wherein the radio bearer configuration indicates a first set of radio bearers configured for at least one mobile originated small data transmission and a second set of radio bearers configured for at least one mobile terminated small data transmission.

13. The apparatus of claim 1, wherein the information is comprised in at least one of:
user equipment assistance information,
a radio resource control resume complete message,
a radio resource control setup complete message, or
a radio resource control reconfiguration complete message.

14. The apparatus of claim 1, wherein the apparatus comprises a terminal device.

15. The apparatus of claim 1, wherein the set of radio bearers comprises one or more radio bearers.

16. An apparatus comprising:
at least one processor; and
at least one memory storing instructions that, when executed by the at least one processor, cause the apparatus to perform:
receiving, from a terminal device, information indicating a set of radio bearers applicable to be configured in at least one small data transmission configuration.

17. The apparatus of any of claims 16, wherein the apparatus is caused to perform:
determining the at least one small data transmission configuration based on the information; and
transmitting, to the terminal device, the at least one small data transmission configuration.

18. The apparatus of claim 16, wherein the apparatus is caused to perform:
transmitting, to the terminal device, a first request for indicating at least one radio bearer applicable to be configured in the at least one small data transmission configuration; and
receiving, from the terminal device, the information indicating the set of radio bearers.

19. The apparatus of claim 16, wherein the apparatus is caused to perform:
transmitting, to the terminal device, other information indicating a data amount threshold for initiating a small data transmission procedure.

20-31. (canceled)

32. A method, comprising:
transmitting, by a terminal device and to a network device, information indicating a set of radio bearers applicable to be configured in at least one small data transmission configuration.

33-37. (canceled)
